(19) United States
(12) Patent Application Publication
(10) Pub. No.: US 2021/0162858 A1
(43) Pub. Date: Jun. 3, 2021

(54) DEVICE FOR CONTROLLING AN AIR FLOW CIRCULATING IN A HEAT EXCHANGER FOR A MOTOR VEHICLE AND COOLING MODULE PROVIDED WITH SUCH A DEVICE

(71) Applicant: Valeo Systemes Thermiques, Le Mesnil Saint Denis Cedex (FR)

(72) Inventors: Enzo Mitidieri, Le Mesnil Saint Denis (FR); Sylvain Gerber, Le Mesnil Saint Denis (FR); Karim Arab, Le Mesnil Saint Denis (FR)

(73) Assignee: Valeo Systemes Thermiques, Le Mesnil Saint Denis Cedex (FR)

(21) Appl. No.: 17/046,516

(22) PCT Filed: Apr. 1, 2019
(86) PCT No.: PCT/FR2019/050753

§ 371 Date: Oct. 9, 2020

(30) Foreign Application Priority Data
Apr. 9, 2018 (FR) 1853056

(51) Int. Cl. B60K 11/08

(52) U.S. Cl. CPC B60K 11/085

(57) ABSTRACT

The invention relates to a regulating device (10) for regulating a flow (F) of air intended to circulate through a heat exchanger for a motor vehicle, the device comprising at least two curtains (11) able to move in a direction of opening/closing (Z), a transmission system (20) connected fixedly or via a mechanical connection having a limited number of degrees of freedom, to at least two rigid drive members (30), said drive members (30) being able to drive said curtains (11) between a closed position (P_{F}) that blocks off the passage of the flow (F) of air and an open position (P_{O}) that allows the flow (F) of air to pass by moving in said direction of opening/closing (Z).

### FIELD OF THE INVENTION

The invention relates to a device for controlling a flow of air circulating in a heat exchanger for a motor vehicle and to a cooling module provided with such a device. It is intended in particular for equipment of a motor vehicle front end.

### PRIOR ART

Motor vehicle cooling modules comprising two heat exchangers are known. A first heat exchanger has the function of cooling an auxiliary circuit of the vehicle, such as an air conditioning device or a charge air cooling device. A second heat exchanger is needed for cooling the engine of the vehicle. These heat exchangers are arranged in the front end of the vehicle, assembled and aligned in series so that the airflow entering through the vehicle radiator grille passes through them in succession. They typically comprise a heat exchange core bundle comprising tubes in which the fluid that is to be cooled circulates and through which the air coming from the grille passes.

In order to separate the cooling of the two heat exchangers and optimize the aerodynamic performance of each heat exchanger, the applicant has recently proposed a device for regulating the flow of air intended to circulate in heat exchangers, in an unpublished patent application by the applicant. The regulating device comprises two curtains mounted in a frame and able to be moved alternately in translational movement between two positions: open and closed. By moving according to these two positions, the curtains allow the regulating device to allow the passage or alternatively to block the passage of the flow of air passing through the radiator grille of the motor vehicle. The curtains are moved by means of a transmission system which guides the movement of said curtains in translational movement, and an actuator causing the transmission system to move. The transmission system is equipped with a set of belts and pulleys which is connected to the curtains by filamentary connections.

One disadvantage with this device lies in the limited ability of the curtain-moving members to withstand thermal shock. Now, such members may be faced with temperature variations because of the proximity of the exchangers. In the event of an excessively great expansion, the driving of the curtains may thereby be disrupted, and this detracts from correct control of the level of opening/closing of the curtains and therefore from correct regulation of the temperature of the fluids circulating in the exchanger.

It is an objective of the invention to at least partially overcome the aforementioned disadvantages and the invention for this reason proposes a device for regulating a flow of air intended to circulate through a heat exchanger for a motor vehicle, the device comprising at least two curtains able to move in a direction of opening/closing, a transmission system connected fixedly or via a guided mechanical connection, to at least two rigid drive members, said drive members being able to drive said curtains between a closed position that blocks off the passage of the flow of air and an open position that allows the flow of air to pass by moving in said direction of opening/closing.

What is meant by “fixedly or via a guided mechanical connection” is that the transmission system is connected to said rigid drive members by a non-flexible connection. This in particular is a fixed connection or connection with just one degree of freedom, for example a connection in translation.

This then yields a regulating device of which the elements exhibit high resistance to thermal shock, which means that they are more able to withstand the temperature variations caused by the heat exchanger(s) situated nearby.

The regulating device according to the invention thus makes it possible to limit the uncertainty regarding the degree of opening/closing of the curtains and thereby optimize the regulation of the temperature of the fluids circulating through the heat exchanger(s).

According to various features of the invention which may be considered together or separately:
the drive members are drive rods connected to the curtain;
said transmission system is configured so that said curtains move symmetrically with respect to one another;
the regulating device comprises at least one actuator configured to drive said transmission system;
said device comprises at least one shaft for rolling-up/unrolling the curtains;
said shaft for rolling-up/unrolling the curtains comprises means for tensioning the curtains;
in a first variant, said transmission system comprises at least one pinion;
said actuator comprises a drive shaft, said drive shaft being able to effect a rotational movement about an axis oriented in a direction Y perpendicular to a direction Z, corresponding to the direction of opening/closing, in a plane of extension of the curtains in the closed position;
said pinion is connected with said actuator, notably said drive shaft, so as to be guided in rotation by said drive shaft;
said transmission system comprises two toothed spindles meshing with said pinion;
said toothed spindles oppose one another in a direction X orthogonal to the plane of extension of the curtains in the closed position;
said drive members are connected fixedly to said toothed spindles;
in a second variant, said transmission system comprises an endless screw with threads of opposing hand, which is coupled to the actuator;
said actuator comprises a drive shaft, said drive shaft being able to effect a rotational movement about an axis oriented in a direction Y perpendicular to a direction Z, corresponding to the direction of opening/closing, in a plane of extension of the curtains in the closed position;
said actuator comprises a first angle member connected to the drive shaft and having a beveled edge;
the transmission member comprises a second angle member connected to the endless screw and having a beveled edge, said edge of the second angle member conforming to the beveled edge of the first angle member;
said endless screw is coupled to the drive shaft via said first and second angle members;
said transmission system further comprises a first nut with a right-hand thread and a second nut with a left-hand thread, said first and second nuts meshing with the endless screw;
said drive members are connected to said nuts fixedly;
in a third variant, the actuator comprises at least two drive shafts each connected to said actuator(s), said drive shafts being able to effect a rotational movement about axes oriented in a direction X orthogonal to the plane of extension of the curtains in the closed position;
a first and a second of the drive shafts are connected by a belt;
the transmission system comprises two pushing arms which are coupled to the drive shafts, said pushing arms being guided in rotation by the drive shafts;
said transmission system comprises two carriages, said carriages being coupled to the pushing arms by a pivot connection and to the drive members by a slideway connection;
each of said drive members is connected to a slider, said slider being guided in a first slideway, said first slideway being fixed to a first lateral beam of a frame holding said curtains;
each of said drive members is connected to a second slider, said slider being guided in a second slideway, said second slideway being fixed to a second lateral beam of the frame;
the second beam is opposite the first lateral beam of the frame;
in another variant, said transmission system comprises:
   at least two pushing arms able to effect a rotational movement about an axis of rotation orthogonal to a plane of extension of the curtains in the closed position,
   at least two carriages able to move between a proximal position and a distal position along said drive members, under the action of the pushing arms,
   the transmission system being configured in such a way as to convert the rotational movement of the pushing arms into a translational movement of the drive members in the direction of opening/closing, via said carriages.
   That yields a regulating device in which the operation of the transmission system is reliant on the conversion of a rotational movement through a limited angle into a translational movement, forcing the curtains to move in the direction of opening/closing. That on the one hand allows the forces to be transmitted effectively between the various elements that make up the device and, on the other hand, makes it possible to substantially increase the speed of travel of the drive members, situated at the output side of the transmission system.

The invention also relates to a cooling module comprising a regulating device as described above.

Advantageously, the module comprises:
a low-temperature heat exchanger,
a high-temperature heat exchanger,

the low-temperature heat exchanger being positioned upstream of the regulating device, and the high-temperature heat exchanger being positioned downstream of the regulating device.

### PRESENTATION OF THE FIGURES

Other objects, features and advantages of the invention will become more clearly apparent from the description which follows, given with reference to the appended figures, in which:

FIG. 1a schematically illustrates, in side view, the front end of a vehicle comprising a cooling module equipped with a regulating device according to a first embodiment of the invention;

FIG. 1b is a view of FIG. 1a zooming in on the area of the regulating device;

FIGS. 1c, 2a and 3a illustrate, in a schematic face-on view, a regulating device according to the first, a second and a third embodiment of the invention, respectively, with the curtains in the open position;

FIGS. 1d, 2b and 3b illustrate, in a schematic face-on view, a regulating device according to the first, the second and the third embodiments of the invention, respectively, with the curtains in the closed position;

### DETAILED DESCRIPTION

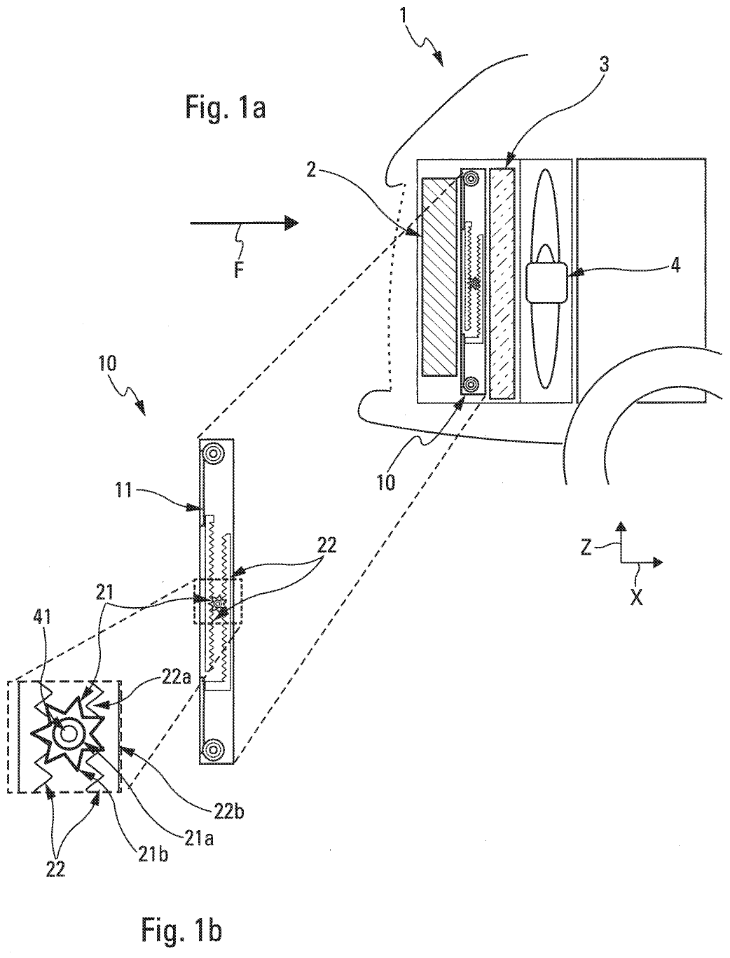

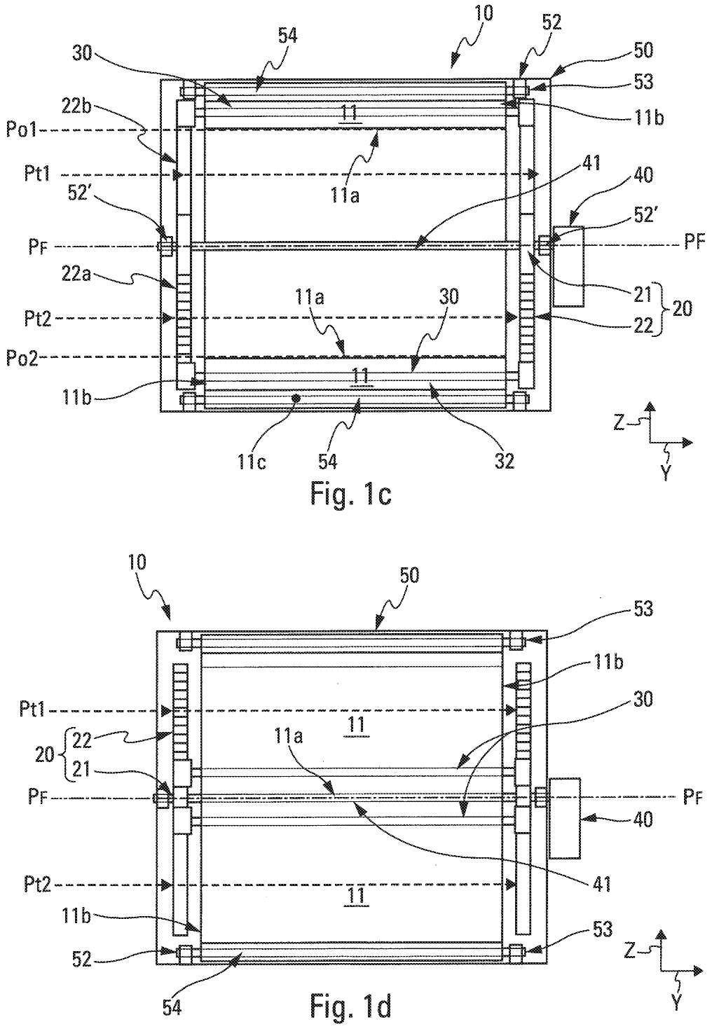

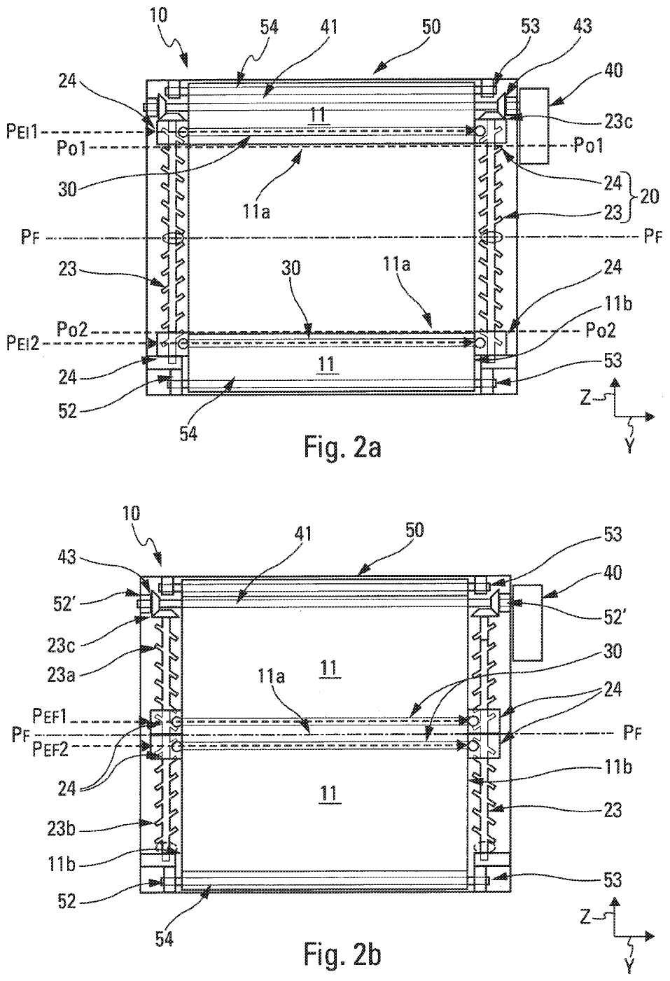

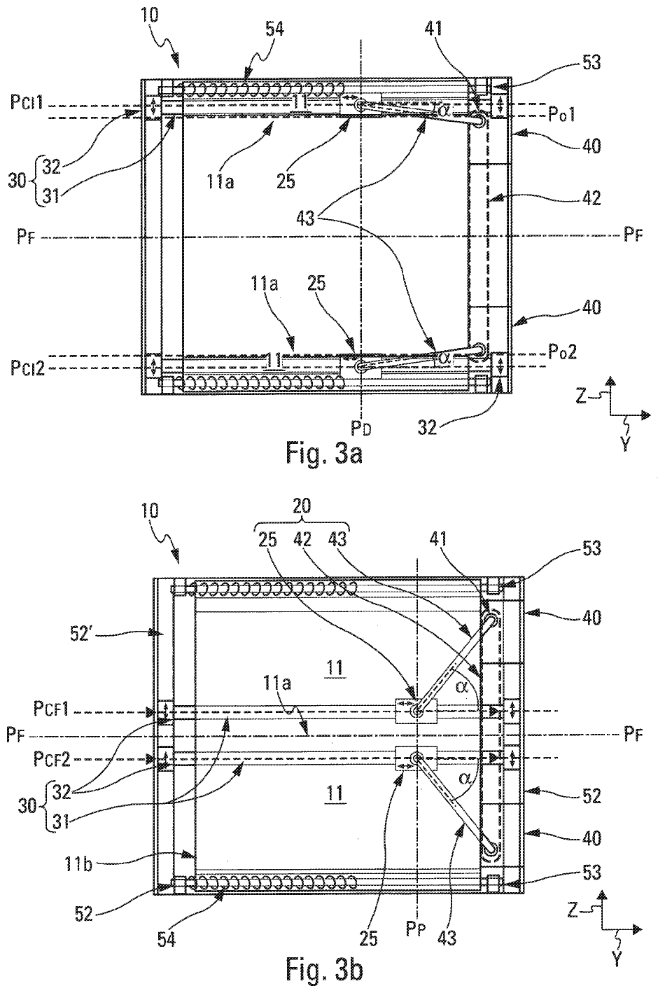

FIGS. 1a to 1 d illustrate a first embodiment of the invention. FIG. 1a illustrates a regulating device 10 regulating a flow F of air, and a cooling module 1, both according to the invention, in a side view. The cooling module 1 extends depthwise in a direction X intended to correspond to the longitudinal axis of the vehicle equipped. The flow F of air is substantially parallel to the direction X. The module is configured to be fixed to a support, such as a chassis of the vehicle.

The cooling module 1 comprises an upstream heat exchanger 2 (situated to the left in FIG. 1a) and a downstream heat exchanger 3 (situated to the right in FIG. 1a) which are arranged in series in the direction of flow of the flow F of air passing through them. In other words, the cooling module 1 is configured to be arranged on its support in such a way that the upstream heat exchanger 2 has the flow F of air passing through it first, and the downstream heat exchanger 3 second.

The upstream heat exchanger 2 is a cooling radiator, referred to as low temperature, used to cool a liquid coolant of a heat-exchange loop, referred to as a low-temperature loop, notably comprising a charge air cooler and/or an air conditioning condenser. The downstream heat exchanger 3 is, for example, a high-temperature cooling radiator intended to cool a liquid coolant of a heat exchange loop comprising an engine of the vehicle. The air which passes through this downstream exchanger 3 cools the engine coolant.

Each exchanger 2, 3 comprises for example a heat exchange core bundle and header tanks positioned laterally on either side of the core bundle (not illustrated). The core bundle has the flow F of air passing through it. It comprises a set of mutually parallel tubes opening into the header chambers, for the circulation of the liquid coolant (not illustrated).

The cooling module 1 is advantageously configured to allow a substantially fluidtight flow of air between said heat exchangers 2, 3, which is to say that the upstream heat exchanger 2 and the downstream heat exchanger 3 are assembled with one another in such a way that the downstream heat exchanger 3 does not have air coming from outside the module passing through it directly. In other words, the flow F of air passing through the downstream heat exchanger 3 comes from the flow of air passing through the upstream heat exchanger 2. For that, the cooling module 1 may, for example, comprise sealing means guiding all of the flow of air that has passed through the upstream heat exchanger 2 toward the downstream heat exchanger 3 without a loss of air throughput. These sealing means, which are not illustrated, may for example comprise ducting arranged between the two heat exchangers 2, 3.

To facilitate the passage of the flow of air through the cooling module 1, notably when the vehicle is stationary, the module advantageously comprises a motorized fan unit 4 able to cause the air to circulate through the cooling module 1. As illustrated in FIG. 1a, the motorized fan unit 4 in this instance is positioned downstream of the downstream heat exchanger 3, the motorized fan unit 4 being configured to draw air from an air intake of the vehicle, which is preferably defined by the radiator grille thereof.

The cooling module 1 according to the invention further comprises a regulating device 10 regulating the air flow and preferably positioned between the upstream heat exchanger 2 and the downstream heat exchanger 3. The regulating device 10 has a small thickness in the depth of the cooling module. The regulating device 10 controls the passage of the flow F of air from the upstream heat exchanger 2 toward the downstream heat exchanger 3 via blinds or curtains 11 that can be rolled-up/unrolled.

In a variant, the cooling module 1 according to the invention may comprise a single heat exchanger, for example a cooling radiator, said regulating device 10 then being arranged upstream or downstream of said heat exchanger. In such a configuration, the flow F of air passing through the heat exchanger comes from the flow F of air passing through the regulating device or opens onto said regulating device.

The cooling module is able to be rotated by 90° in the direction X without the operation of the regulating device being impaired, depending on the architecture of the exchangers. By way of example, such architectures may be used for the purposes of reducing thermal shock.

With reference to FIGS. 1c and 1d, the regulating device 10 according to a first embodiment of the invention is illustrated in a schematic face-on view. The device comprises two curtains 11 of rectangular overall shape. Each curtain 11 is delimited by a proximal edge 11a, two lateral edges 11b, and a distal edge 11c. Said lateral edges 11b are opposite and substantially parallel to a direction Z, orthogonal to the direction X, while said proximal edge 11a and said distal edge 11c are opposite and substantially parallel to a direction Y, orthogonal to the directions X and Z, the direction Z here representing the vertical.

In FIG. 1c, the regulating device 10 is in the open position P_{O}, which means to say that the curtains 11 allow the airflow F to pass. In this configuration, the proximal edges 11a of said curtains 11 are distant from one another. More specifically, a first proximal edge 11a is situated in the vicinity of an upper beam of a frame 50 of the regulating device, notably at the level of a first open position P_{O1}, whereas a second proximal edge 11a is situated in the vicinity of a lower beam of the frame 50, notably at the level of a second open position P_{O2}, opposite to P_{O1} with respect to an axis passing through a dotted line P_{F}-P_{F}.

The regulating device 10 further comprises shafts 53 for rolling-up/unrolling the curtains, and which are connected to the frame 50 by articulating bearings 52.

As a preference, each curtain 11 is kept taut by a tensioning means 54 connected to its distal edge 11c. The tensioning means 54 apply a force to the curtains 11 so that said curtains are continuously kept taut. For example, the tensioning means 54 may be springs, notably spiral springs, or any other means that allows said curtains 11 to be kept taut. As a preference, each tensioning means 54 is connected on the one hand to the frame 50 and on the other hand to the rolling-up/unrolling shaft 53.

In FIG. 1d, the regulating device 10 is in the closed position RE. The curtains 11 extend in a plane, referred to as the plane of extension of the curtains in the closed position. Said plane of extension of the curtains in the closed position is oriented in the direction Z, corresponding to the direction of opening/closing of the curtains, and to the direction Y. In other words, said plane of extension of the curtains in the closed position extends transversely to the air flow F. In this configuration, the respective proximal edges 11a of said curtains are in contact with one another at the dotted line P_{F}-P_{F}. The curtains 11 therefore block off the passage of the flow F of air which circulates perpendicular to the plane of extension of the curtains in the closed position.

The regulating device 10 is configured so that said curtains 11 are able to move in the direction of opening/closing Z, in said plane of extension of the curtains in the closed position. In other words, the device is able, alternately, to adopt the configurations illustrated in FIGS. 1c and 1d. For this purpose, the regulating device 10 comprises a transmission system 20 and at least two drive members 30 connected to said transmission system 20.

The features and the principle of operation of a first embodiment of the transmission system 20 are described hereinbelow with reference to FIGS. 1b and 1c.

As a preference, the transmission system 20 comprises pinions 21. As can best be seen in FIG. 1b, said pinions 21 comprise a peripheral edge 21a and a toothset 21b situated on said peripheral edge 21a. The pinions 21 are able to pivot, in the clockwise direction or, conversely, in the counterclockwise direction, about an axis oriented in the direction Y.

For this purpose, the regulating device 10 preferably comprises at least one actuator 40 configured to drive said transmission system 20. The actuator comprises a drive shaft 41, able to rotate about the axis of rotation of said pinions 21. The actuator 40 further comprises a hydraulic or pneumatic cylinder or, more generally, any drive member able to induce a rotational movement of the drive shaft 41. The drive shaft 41 is connected with the pinions 21. As a preference, the drive member of the actuator 40 is situated outside of the frame 50.

As a preference, said drive shaft 41 is a cylindrical spindle extending between two lateral beams of the frame 50, in a plane orthogonal to the plane of extension of the curtains in the closed position, and along the dotted line P_{F}-P_{F}. As a preference, an inner edge of the pinions 21 conforms to the shape of the drive shaft 41, which means to say that said inner edge espouses the contour of the drive shaft 41 so that said pinions 21 can be guided in rotation by the drive shaft 41. The drive shaft 41 is articulated on bearings 52′ which are connected to the frame 50.

The transmission system 20 may further comprise two racks or toothed spindles 22 substantially parallel to the direction Z. As can best be seen in FIG. 1b, each toothed spindle 22 has a toothset 22a and a plane edge 22b. Said toothed spindles 22 mesh with said pinion 21 via their respective toothsets 22a. In other words, the toothset 22a of the toothed spindles 22 conforms exactly to the toothset 21b of the pinion 21. The toothed spindles 22 are situated on either side of the pinion 21 in the direction X. Thus, in FIG. 1c, a first toothed spindle 22, of which the toothset 22a can be seen in a position Pₜ₂, is connected to a first curtain 11 situated below the dotted line P_{F}-P_{F}, whereas a second toothed spindle 22, of which the plane edge 22b can be seen in a position Pₜ₁, is connected to a second curtain 11 situated above the dotted line P_{F}-P_{F}.

When the pinion 21 turns, the toothed spindles 22, of which the toothsets 22a can be seen in the position Pₜ₂ slide in the direction of the upper beam of the frame 50, namely toward the position Pₜ₁, while at the same time, the toothed spindles 22 of which the plane edges 22b can be seen in the position Pₜ₁ slide in the direction of the lower beam of the frame 50, namely the position Pₜ₂. The toothed spindles 22 are therefore able to effect translational movements that are symmetrically opposed in the direction Z.

Advantageously, the pinions 21 and a corresponding pair of toothed spindles 22 are situated symmetrically on each side of said curtains 11. In this configuration, when the actuator 40 is in operation, the transmission system 20 is capable of driving the drive members 30, to which it is connected, while maintaining the horizontality of said drive members with respect to the direction Y.

As mentioned previously, the regulating device 10 further comprises at least 10 drive members 30. Their features and their operation are described hereinbelow.

In general, said drive members 30 are connected to the transmission system 20. Said drive members 30 are rigid. Furthermore, said drive members 30 are connected, fixedly or with guided mechanical connection, to the transmission system 20. Once again stated differently, said drive members 30 are not connected to the transmission system 20 in a filamentary manner. That makes it possible to improve the ability of the regulating device 10 to withstand both mechanical stress and thermal shock. It also allows the regulating device 10, and the installation thereof, to be simplified.

More specifically, in the embodiment of FIGS. 1a to 1 d, each drive member 30 is attached to one of said toothed spindles 22 such that any sliding of said toothed spindles 22 in the direction Z leads to a translational movement of said members 30 in the same direction. For example, the toothed spindle 22, of which the toothset 22a moves from the position P_{T1} to the position P_{T2}, leads to a movement of the drive member 30, to which it is connected, from a distal position close to the rolling-up/unrolling shaft 53 toward a proximal position close to the shaft 41.

As a preference, the drive members 30 are rigid drive rods. Said drive rods 30 connect together, in twos, said toothed spindles 22 and are able to be translationally guided by said toothed spindles 22. Said drive rods 30 are directly connected to said curtains 11, so that any translational movement of said drive rod in the direction Z induces a translational movement of said curtain 11 in the same direction. Furthermore, because the drive members 30 are kept horizontal by the duplication of the pinion 21 and of the rods 22 on each side of the curtains 11, the edges 11a are therefore kept horizontal. That also allows loads to be distributed symmetrically over the drive members 30.

As can best be seen in the example illustrated in FIG. 1b, the toothed spindle 22 situated in the upper part (to the left in the drawing) is rectilinear, and the associated drive rod is attached to an upper end of said toothed spindle 22, The toothed spindle 22 situated in the lower part (to the right in the drawing) has an L-shaped configuration, the long leg of the L having the toothset and the short leg ending in the continuation of the other toothed spindle 22. The drive rod associated with the L-shaped toothed spindle 22 is situated at the free end of said short leg of the L, such that the two curtains 11 are substantially in the same plane.

In a variant, said drive members 30 may be studs connected fixedly on the one hand to the transmission system 20 and on the other hand to the curtains 11. The studs are provided on each side of each of the curtains 11, each proximal corner of the curtains therefore being fixed to said studs.

The principle of closing the curtains 11 is as follows.

When the actuator 40 is activated, the pinions 21 effect a rotational movement about their axis of rotation. This rotational movement of the pinions 21 induces a translational movement of the toothed spindles 22 which are respectively associated with them, in the direction Z. As illustrated in FIG. 1d, said toothed spindles 22, of which the toothsets 22a are initially situated in a position Pₜ₂, move from the position Pₜ₂ toward the position Pₜ₁, and, conversely, the toothed spindles 22 of which the plane edges 22b are initially situated in the position Pₜ₁, move from said position Pₜ₁ toward the position Pₜ₂.

Incidentally, the drive members 30 connected to said toothed spindles 22 are simultaneously guided in translation in opposite directions and drive the curtains 11 in their movement. As they move, the drive members 30 guide said curtains 11 such that their proximal edges 11a, initially situated in positions P_{O1} and P_{O2}, reach the closed position P_{F} and find themselves in contact with one another, or are even overlapping.

Because the two pinions 21 are driven simultaneously by the drive shaft 40, the curtains 11 are guided symmetrically with respect to one another as they move. The distance separating the two curtains 11, notably the proximal edges 11a thereof, remains equal on either side of the dotted line P_{F}-P_{F}, throughout their entire movement. When the curtains 11 are in contact, or even overlapping, they therefore do not allow the passage of the flow F of air circulating perpendicular to the plane of extension of the curtains in the closed position.

Conversely, the curtains 11 are able to return to their original position (as illustrated in FIG. 1c) by moving in the direction of opening/closing Z, for example when the actuator 40 is no longer in operation. Specifically, because the curtain tensioning means 54 continuously exert a force on the curtains 11, said curtains 11 roll up again around their respective rolling-up/unrolling shaft 53 and the elements of said transmission system 20 and the drive members 30 return to their original position.

FIGS. 2a and 2b illustrate, in a schematic face-on view, a second embodiment of the invention. This embodiment of the invention differs from the previous one through the features and operation of the transmission system 20 and of the drive members 30. All the rest, notably everything relating to said curtains 11 and their layout within the frame 50, is unchanged.

Thus, in a similar way to the first embodiment, said curtains 11 are able to move in the direction of opening/closing Z in said plane of extension of the curtains in the closed position, and the regulating device 10 for that purpose comprises a transmission system 20 and at least two drive members 30 which are connected to said transmission system 20.

The transmission system 20 according to this second embodiment comprises an endless screw 23 substantially parallel to the direction Z. Said endless screw 23 has a cylindrical overall shape and comprises screw threads of opposing hand. More specifically, an upper portion of said endless screw 23, notably situated above the dotted line P_{F}-P_{F}, comprises helical splines 23a oriented to the left or to the right, whereas a lower portion of said endless screw 23, notably situated below the dotted line P_{F}-P_{F}, comprises splines 23b oriented in the opposite direction, for example to the left if the thread of said upper portion is oriented to the right.

Said endless screw 23 is coupled to an actuator 40. As in the previous embodiment, the actuator 40 comprises a drive shaft 41 driven in rotation by the drive member about an axis oriented in the direction Y. Said drive member and said drive shaft 41 are similar in their respective nature and mode of operation, to that which was seen in the first embodiment, and differ only in terms of the features mentioned in the sections which follow.

As a preference, said drive shaft 41 comprises, at one of its ends, a first angle member 43. Said angle member 43 has a plane edge in direct contact with a bearing 52′ and a beveled edge in direct contact with said endless screw 23. For this purpose, the endless screw 23 also comprises a second angle member 23c. Said endless screw 23 is coupled to the drive shaft 41 via their said angle members 43, 23c. In this configuration, when the angle member 43 effects a rotational movement, induced by the drive shaft 41, about an axis oriented in the direction Y, that leads to a rotational movement of the endless screw 23, via the angle member 23c, about an axis oriented in the direction Z.

The transmission system 20 may further comprise two nuts 24 meshing with the endless screw 23 and situated in a position P_{EI1} and in a position P_{EI2}, respectively. More specifically, one of said nuts 24 meshes with the upper portion of the endless screw, while the other meshes with the lower portion of the endless screw. For this purpose, a first nut 24 has a right-hand thread and a second nut 24 has a left-hand thread.

In such a configuration, when the endless screw 23 rotates about an axis oriented in the direction Z, the first nut 24 moves between the position P_{EI1} and a position P_{EF1}, while the second nut 24 moves in the other direction between the position P_{EI2} and a position P_{EF2}, symmetrically opposed to the position P_{EF1} with respect to the axis passing through the dotted line P_{F}-P_{F}.

Advantageously, the endless screw 23 and said corresponding nuts 24 are duplicated on each side of said curtains 11. In this configuration, when the actuator 40 is in operation, the transmission system 20 is capable of driving the drive members 30, to which it is connected, while maintaining the horizontality of said drive members 30 with respect to the direction Y.

Said drive members 30 are connected here to the nuts 24. Incidentally, any movement of said nuts 24 in the direction Z leads to a translational movement of the drive members 30 in the same direction. For example, when the first nut 24 effects a translational movement toward the position P_{EF2}, said first nut 24 guides in translation the drive member 30 to which it is connected, from a distal position close to the rolling-up/unrolling shaft 53, toward a proximal position, close to the drive shalt 41.

As in the previous embodiment, said drive members 30 may be a rod or, as an alternative, studs connected directly to the curtains 11. Thus, any translational movement of the guide members 30 in the direction Z leads to a translational movement of said curtain 11 in the same direction. Furthermore, because the drive members 30 are kept horizontal by the duplication of the endless screw 23 and of the nuts 24 on each side of the curtains 11, the edges 11a are therefore kept horizontal. That advantageously allows loads to be distributed symmetrically over the drive members 30.

The principle of closing of the curtains 11 is as follows.

When the actuator 40 is in operation, the endless screws 23 situated on each side of said curtains 11 move about their axes. This rotational movement of the endless screws 23 induces a movement of the nuts 24 respectively associated with these screws. The nuts 24 thus effect translational movement along the splines 23a, 23b of the endless screw. The first nut 24, initially situated in the position P_{EI1}, moves from the position P_{EI1} toward the position P_{EF1}, and the second nut 24, initially situated in the position P_{EI2}, moves from the position P_{EI2} toward the position P_{EF2}.

Incidentally, the drive members 30 connected to the nuts 24 are simultaneously guided in translation in opposite directions and drive the curtains 11 in their movement. As they move, the drive members 30 connected to the first curtain 11 guide said first curtain 11 in translation, so that its proximal edge 11a, initially situated in a first open position P_{O1}, moves toward the closed position P_{F} while remaining essentially horizontal. At the same time, said second curtain 11 is guided in translation so that its proximal edge 11a, initially situated in a second open position P_{O2}, symmetrically opposed to the first open position P_{O1} with respect to the axis passing through the dotted line P_{F}-P_{F}, moves toward the closed position P_{F} while remaining essentially horizontal.

Because the two endless screws 23 are driven simultaneously by the drive shaft 41, the curtains 11 are guided symmetrically with respect to one another as they move. The distance separating the two curtains 11, notably the proximal edges 11a thereof, remains equal on either side of the dotted line P_{F}-P_{F}, throughout their entire movement. When the curtains 11 are in contact, or even overlapping, they therefore do not allow the passage of the flow F of air circulating perpendicular to the plane of extension of the curtains in the closed position.

Conversely, the curtains are able to return to their original position (illustrated in FIG. 2a) by moving in the direction of opening/closing Z, for example when the actuator 40 is no longer in operation. Specifically, because the curtain tensioning means 54 continuously exert a force on the curtains 11, said curtains 11 roll up again around their respective rolling-up/unrolling shaft 53 and the elements of said transmission system 20 and the drive members 30 return to their original position.

FIGS. 3a and 3b illustrate, in a schematic face-on view, a third embodiment of the invention. This embodiment of the invention differs from the previous ones through the features and operation of the transmission system 20 and of the drive members 30. All the rest, notably everything relating to said curtains 11 and their layout within the frame 50, is unchanged.

Thus, in a similar way to the preceding embodiments, said curtains 11 are able to move in the direction of opening/closing Z in said plane of extension of the curtains in the closed position, and the regulating device 10 for that purpose comprises a transmission system 20 and at least two drive members 30 which are connected to said transmission system 20.

In this embodiment, the transmission system 20 may adopt one of two configurations.

In a first configuration, the transmission system 20 comprises two actuators 40, each one equipped with a drive shaft 41. Unlike in the preceding embodiments, the drive shafts 41 extend orthogonally to the plane of extension of the curtains in the closed position, notably along axes oriented in the direction X, and are able to rotate about said axes.

Furthermore, still in this first configuration, each drive shaft 41 is coupled to a pushing arm 43 and is moreover able to guide said pushing arm 43 in terms of rotation. Thus, when said drive shafts 41 rotate about the axis of rotation thereof, said pushing arms 43 are able to rotate about the same axis. In this configuration, because said pushing arms 43 are not driven by the same actuator 40, the regulating device 10 may advantageously comprise a synchronizing device so that the pushing arms 43 can be driven synchronously, or not.

Alternatively, in a second configuration, the transmission system 20 comprises a single actuator 40 connected to a first drive shaft 41. In a similar way to the first configuration, said first drive shaft 41 is configured to effect a rotational movement about an axis oriented in the direction X. In this second configuration, a belt 42 connects said first drive shaft 41 to a second drive shaft 41.

Advantageously, the belt 42 may be toothed, namely said belt 42 may comprise teeth. Thus, when said first drive shaft 41 turns, that drives the belt 42 which simultaneously, which means to say synchronously, drives said first drive shaft 41 and said second drive shaft 41. Advantageously, said pushing arms 43 may therefore be simultaneously guided in rotation by the drive shafts 41 without the need to resort to a device for synchronizing two distant actuators.

As a preference, said pushing arms 43 adopt a generally cylindrical shape with a first end connected to a drive shaft 41 and a second end connected to a carriage 25 of the transmission system. Said carriages 25 are pivot-connected to the pushing arms 43 in the direction X orthogonal to the plane of extension of the curtains in the closed position. Thus, when the pushing arms 43 effect a rotational movement about their axis of rotation, said carriages 25 are driven in their turn.

Each carriage 25 is furthermore coupled to one of the drive members 30. Each drive member 30 comprises a drive rod 31 along which the carriage 25 is in a sliding connection, which means to say that the carriage 25 is guided in translation along the drive rod 31. Incidentally, because the carriages 25 are guided by said pushing arms 43 while at the same time being guided in said drive rods 31, the rotational movement of the pushing arms 43 induces a translational movement of the carriages 25 along said drive rods, notably between a distal position P_{D} and a proximal position P_{P}. In addition, as they move, the carriages 25 induce a translational movement of a first of the drive rods 31 toward the position P_{CF1} and of a second of the drive rods 31 toward the position P_{CF2}, symmetrically opposed to the position P_{CF1} with respect to the axis passing through the dotted line P_{F}-P_{F}. The two drive rods 31 are therefore able to move in the direction Z, in opposite directions.

In the configuration shown in FIG. 3a, i.e. when the regulating device 10 is in the open position, each pushing arm 43 makes an angle α comprised between 10 and 20° with respect to the drive members 30. Furthermore, the pushing arms 43 are able to rotate, so as to reach the configuration illustrated in FIG. 3b. In that configuration, the pushing arms 43, which initially make an angle comprised between 10 and 20° with respect to the drive members 30, now make an angle comprised between 40 and 50° with respect to said drive members 30.

Each drive member 30 further comprises two sliders 32, connected to the drive rod 31 and situated on each side of said curtains 11. Said sliders 32 are guided in slideways 52 fixed to the lateral beams of the frame 50 and parallel to said beams. In such a configuration, the sliders 32 are guided in translation in the slideways 52 in the direction Z. Advantageously, that allows the drive rods 31 to move along the same axis while remaining horizontal, namely parallel to the direction Y.

As in the preceding embodiments; said drive rods 31 are directly connected to the curtains 11, so that any translational movement of said drive rods 31 in the direction Z induces a translational movement of said curtains 11 in the same direction.

As an alternative, said drive members 30 may be studs connected directly to corners of the curtains 11.

The principle of closing of the curtains 11 is as follows.

When the actuator(s) 40 is (are) in operation, the pushing arms 43 effect a rotational movement about their axis (axes) of rotation. During this rotational movement, the pushing arms 43, which initially make an angle comprised between 10 and 20° with respect to the direction Y, now make an angle comprised between 40 and 50°. The rotational movements of the pushing arms 43 cause the carriages 25 to slide along the drive rods 31 from a position P_{O} toward a position P_{P} and, at the same time, a translational movement of direction Z from, respectively, a position P_{CI1} toward a position P_{CF1} and a position P_{CI2} toward a position P_{CF2} opposed to the position P_{CF1} with respect to the axis passing through the dotted line P_{F}-P_{F}.

Incidentally, the drive rods 31, guided in translation in the direction Z, notably by means of the sliders 32, drive the curtains 11 in their opposing translational movements. As they move, the drive members 30 connected to the first curtain 11 guide said first curtain 11, so that its proximal edge 11a, initially situated in a first open position P_{O1}, moves toward a closed position P_{F} while remaining essentially horizontal. At the same time, said second curtain 11 is guided in translation from a second open position P_{O2}, opposed to the first open position P_{O1} with respect to the axis passing through the dotted line P_{F}-P_{F}, toward a closed position P_{F}.

Because the two pushing arms 43 are driven simultaneously by the drive shaft 41, the curtains 11 are guided symmetrically with respect to one another, so that the distance separating the two curtains 11, notably the proximal edges 11a thereof, remains equal on either side of the dotted line P_{F}-P_{F}, throughout their movement. When the curtains 11 are in contact, or even overlapping, they therefore do not allow the passage of the flow F of air circulating perpendicular to the plane of extension of the curtains in the closed position.

Conversely, the curtains are able to return to their original position (as illustrated in FIG. 3a) by moving in a direction of opening/closing Z, for example when the actuator 40 is no longer in operation. Specifically, because the curtain tensioning means 54 continuously exert a force on the curtains 11, said curtains 11 roll up again around their respective rolling-up/unrolling shaft 53 and the elements of said transmission system 20 and the drive members 30 return to their original position.

1. A regulating device for regulating a flow of air intended to circulate through a heat exchanger for a motor vehicle, the device comprising:
at least two curtains able to move in a direction of opening/closing;
a transmission system connected fixedly or via a guided mechanical connection, to at least two rigid drive members,
said drive members being able to drive said curtains between a closed position that blocks off the passage of the flow of air and an open position that allows the flow of air to pass by moving in said direction of opening/closing.

2. The regulating device as claimed in claim 1, wherein the drive members are drive rods connected to the curtain.

3. The regulating device as claimed in claim 1, wherein said transmission system comprises at least one pinion.

4. The regulating device as claimed in claim 3, wherein said transmission system comprises two toothed spindles meshing with said pinion, said toothed spindles opposing one another in a direction orthogonal to a plane of extension of the curtains in the closed position.

5. The regulating device as claimed in claim 1, wherein said transmission system comprises an endless screw with threads of opposing hand.

6. The regulating device as claimed in claim 5, wherein said transmission system further comprises a first nut with a right-hand thread and a second nut with a left-hand thread, said first and second nuts meshing with the endless screw.

7. The regulating device as claimed in claim 1, wherein the transmission system comprises two pushing arms which are coupled to drive shafts, said pushing arms being guided in rotation by the drive shafts.

8. The regulating device as claimed in claim 7, wherein said transmission system comprises two carriages, said carriages being coupled to the pushing arms by a pivot connection and to the drive members by a slideway connection.

9. The regulating device as claimed in claim 8, wherein each of said drive members is connected to a slider, said slider being guided in a first slideway, said first slideway being fixed to a first lateral beam of a frame holding said curtains.

10. A cooling module comprising:
a low-temperature heat exchanger;
a high-temperature heat exchanger; and
a regulating device arranged between the two exchangers, the regulating device comprising:
at least two curtains configured to move in a direction of opening/closing,
a transmission system connected fixedly or via a guided mechanical connection, to at least two rigid drive members,
said drive members being able to drive said curtains between a closed position that blocks off the passage of the flow of air and an open position that allows the flow of air to pass by moving in said direction of opening/closing,
the low-temperature heat exchanger being positioned upstream of the regulating device, and
the high-temperature heat exchanger being positioned downstream of the regulating device.

11. A regulating device for regulating a flow of air configured to circulate through a heat exchanger for a motor vehicle, the device comprising:
at least two curtains able to move symmetrically in a direction of opening/closing;
a transmission system connected via a non-flexible connection to at least two rigid drive members; and
at least one shaft for rolling-up/unrolling the curtains, said shaft for rolling-up/unrolling the curtains comprising means for tensioning the curtains,
wherein said drive members drive said curtains between a closed position that blocks off the passage of the flow of air and an open position that allows the flow of air to pass by moving in said direction of opening/closing.
